(19) United States
(12) Patent Application Publication
(10) Pub. No.: US 2013/0151945 A1
(43) Pub. Date: Jun. 13, 2013

(54) Processing Published and Subscribed Events

(71) Applicant: International Business Machines Corporation, Armonk, NY (US)

(72) Inventors: Jie Cui, Beijing (CN); Richard D. Thompson, Yorktown Heights, NY (US); Yuan Wang, Beijing (CN); Jing Min Xu, Beijing (CN)

(73) Assignee: International Business Machines Corporation, Armonk, NY (US)

(21) Appl. No.: 13/662,584

(22) Filed: Oct. 29, 2012

(30) Foreign Application Priority Data
Oct. 31, 2011 (CN) 201110337788.1

(51) Int. Cl. G06F 17/21

(52) U.S. Cl. CPC G06F 17/21
USPC 715/234

(57) ABSTRACT

A method and system for processing published and subscribed events. The method includes the steps of: parsing definitions of published events and subscribed events in widget definition files in a webpage, generating a set of published events and a set of subscribed events, respectively, based on the definitions of the published events and the subscribed events, and generating a definition file of a hidden widget based on the set of published events and the set of subscribed evens, where at least one step is carried out on a computer device.

### CROSS-REFERENCE TO RELATED APPLICATION

This application claims priority under 35 U.S.C. §119 from Chinese Patent Application No. filed 201110337788.1 filed on Oct. 31, 2011, the entire contents of which are incorporated herein by reference.

### BACKGROUND OF THE INVENTION

1. Field of the Invention

The present invention generally relates to information processing technology. More particularly, the present invention relates to a method and system for processing published events and subscribed events.

2. Related Art

Widgets are a kind of currently popular applications. Generally speaking, a widget occupies a small part of region on the desk of a user's operating system, and accomplishes some specific functions.

A widget is an end-to-end application, and the functions it accomplishes are specific and unitary. A widget usually provides a specific configuration function, allowing a user to customize. Since their functions are specific, they have high reusability. Widgets are usually built on some platform, which is responsible for their management; in the mean time, the platform will provide a series of APIs for use by the widgets. A third party can develop its own widgets based on the development specifications provided by the platform, and run the widgets on the platform. Widgets can mainly be classified into the following categories based on the types of the operating platforms: desktop widgets, mobile widgets, and web widgets.

In the following will be described in detail web widgets related to the present invention. Just as the name implies, a web widget uses the web as its operating platform, and can be embedded in a web application. General speaking, the popularity of web widget specifications cannot do without the support of a complete ecosystem. A mature web widget ecosystem shall be composed of the following parts:

Specifications, APIs and documents: This part is mainly for developers. Clearly-defined specifications, APIs and sufficient documents can help developers to develop web widgets more rapidly.

Operating Platform: This part is mainly for end users. End users need this platform to use widgets developed by developers.

Community: A complete web widget ecosystem cannot do without a perfect community support. The community is a bridge between end users and developers. Developers can publish the widgets they have developed, and end users can browser and search for the widgets, and add interested ones into their own runtime environments. In the mean time, the end users can comment and score the web widgets.

Taking the web widget ecosystem by Google® as an example, Google® gadgets have corresponding specifications, and have detailed development documents. The operating platforms for Google gadgets include iGoogle®, Slogger®, Gmail®, etc; Google® offers a gadget directory, and users can publish, comment on and score gadgets. Netvibes® uses the Universal Widget API (UWA) as its specification; netvibes.com is its operating platform; eco.netvibes.com is its community. Web application developers use these specifications and development documents to develop web applications including various widgets.

A related webpage of a web application invokes a related widget container, which is for rendering and managing widgets on the page and is platform independent, and usually is JS API. A widget container can be provided by the server, or by the client, such as JS library, or it can be provided by server-Fclient, and currently there are corresponding tools in the market.

Web widgets communicate with each other through events. Usually there are two types of communication: one is topic-based communications represented by Open Social Gadget®, and the other is defining events and event types, and communicatively connecting events of widgets by programming or end user wiring.

Web widgets are widely used in currently popular Mashup applications. Mashups are a new type of web applications, and they have the features of the second generation of web applications (Web 2.0), and can use contents retrieved from external data sources to create brand-new innovative services. Usually an end user can set up web widgets by dragging, and typical applications are map mashups, video and image mashups, search and shopping mashups and news mashup, etc.

FIG. 1 shows a problem in the prior art. The main search widget needs to publish events to other widgets, and only after the other widgets subscribe to the events and receive the event contents, can they display the corresponding contents. With more and more widgets subscribing to the events, e.g., more filter search widgets and related search widgets added, the main search widget needs to continuously change its implementation, so as to be able to publish events needed by the other widgets. That is, the main search widget needs to amend its code to adapt based on different types of subscribing widgets, which obviously adds much work on development and programming.

FIG. 2 shows another problem in the prior art. The “friends list” widget at the top-left and the Facebook® Fickr®, Twitter® widgets at the bottom need to publish update events about friends to the “friends updates” widget at the top-right, so that the widget will display all the updates about friends. It can be seen that with more and more widgets publishing events, the widget subscribing to the events, i.e., the “friends updates” widget, needs to continuously change the implementation of its code, so as to ensure that more events are received, and this obviously adds much development and programming work.

Therefore, a method and system that can properly improve the current technology are needed to alleviate related development and programming work.

### SUMMARY OF THE INVENTION

A method for processing published and subscribed events. The method includes the steps of: parsing definitions of published events and subscribed events in widget definition files in a webpage, generating a set of published events and a set of subscribed events, respectively, based on the definitions of the published events and the subscribed events, and generating a definition file of a hidden widget based on the set of published events and the set of subscribed events, where at least one step of the method is carried out on a computer device.

A system for processing published and subscribed events. The system includes: at least one computer processor configured to: parse definitions of published events and subscribed events in widget definition files in a webpage, generate a set of published events and a set of subscribed events, respectively, based on the definitions of the published events and the subscribed events, and generate a definition file of a hidden widget based on the set of published events and the set of subscribed events.

### BRIEF DESCRIPTION OF THE DRAWINGS

In order to describe the features and advantages of the embodiments of the present invention in more detail, reference is made to the following accompanying drawings. If possible, same or similar reference signs are used in the accompanying drawings and the description to denote the same or similar parts. In the drawings:

FIG. 1 illustrates an example of publication result of a widget, which shows that a main search widget publishes events to a plurality of subscribing widgets;

FIG. 2 illustrates an example of publication result of a widget, which shows that a plurality of widgets publishes events to a subscribing widget;

FIG. 3 illustrates an embodiment of a method for processing published events and subscribed events according to the present invention;

FIG. 4 illustrates an embodiment of a method for processing published events and subscribed events according to the present invention;

FIG. 5 illustrates a preferred embodiment of a method for generating a definition file of a hidden widget according to the present invention;

FIG. 6 illustrates a system block diagram of a system for processing published events and subscribed events according to the present invention; and

FIG. 7 schematically shows a structural block diagram of a computing device that can implement the embodiments of the present invention.

### DETAILED DESCRIPTION OF THE PREFERRED EMBODIMENTS

In one aspect of the present invention, there is provided a method for processing published events and subscribed events, including: parsing definitions of published events and subscribed events in widget definition files in a webpage; generating a set of published events and a set of subscribed events based on the definitions of the published events and the subscribed events; and generating a definition file of a hidden widget based on the set of published events and the set of subscribed events.

In another aspect of the present invention, there is provided a system for processing published events and subscribed events, including: parsing means configured to parse definitions of published events and subscribed events in widget definition files in a webpage; set generating means configured to generate a set of published events and a set of subscribed events based on the definitions of the published events and the subscribed events; and definition file generating means configured to generate a definition file of a hidden widget based on the set of published events and the set of subscribed events.

By using embodiments of the present invention, web application developers do not need to rewrite the code of a related widget for publishing events or defining events due to an update of the related widget in a web application, and can ensure the normal operation of the original widget of which the code is not amended, so as to save the web application developers large amounts of time and effort, thus saving large amounts of development costs of web applications.

Now detailed description will be made by referring to the exemplary embodiments of the present invention, examples of which are illustrated in the drawings, where the same reference signs denote the same elements throughout the drawings. It should be understood that the present invention is not limited to the disclosed exemplary embodiments. It should also be understood that not every feature of the method and system is necessary for implementing the present invention claimed by any claim. In addition, in the entire disclosure, when a process or method is displayed or described, the steps of the method can be executed in any order or executed simultaneously, unless it can be seen clearly from the context that one step depends on another step executed previously. Further, there can be obvious temporal intervals between the steps.

First a basic concept of the present invention is introduced. Considering the defects in the prior art, the inventor of the present invention finds through long time and arduous study that, due to the flexibility of the publishing and subscription of widgets, the contents of events published and subscribed by the widgets vary greatly, and it is very hard and costly to only rely on program developers passively amending the code of the widgets to adapt to the changes.

The inventor of the present application conceived a new concept of using a hidden widget as a bridge between widgets, which can greatly save the workload of program developers.

As shown in FIG. 3, some widgets can merely publish events, some widgets can merely subscribe to events, while some widgets can both publish events and subscribe to events. The work done by the hidden widget is to match the subscribed events and published events of all the widgets based on the event data types, so as to decompose or combine them, and republish the matched published events in the hidden widget. In this way it can be ensured that the widget publishing events needs not amend its code due to new types of subscription, and the widget subscribing to events needs not amend its code due to the newly published events.

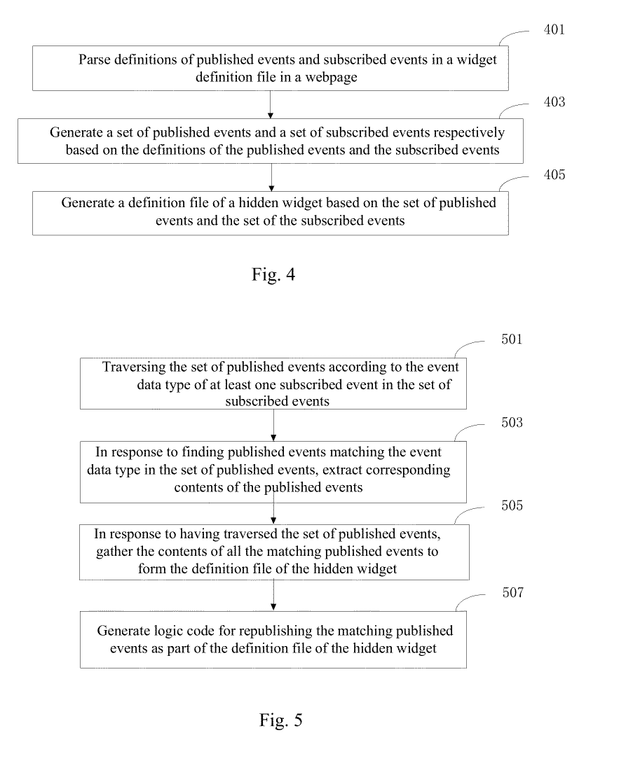

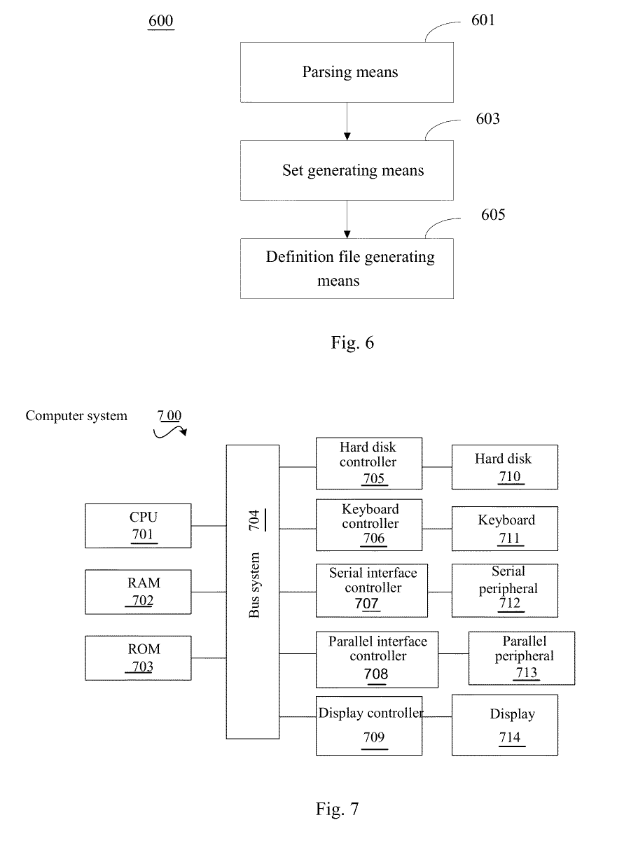

FIG. 4 shows a first specific embodiment of the present invention processing published events and subscribed events, where in step 401, definitions of published events and subscribed events in widget definition files in a webpage are parsed.

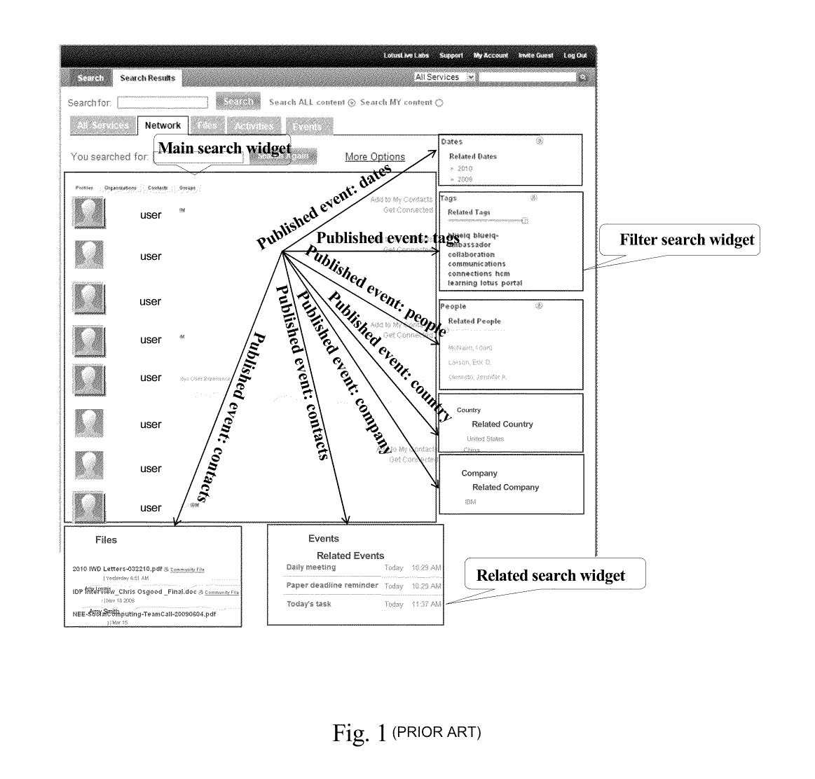

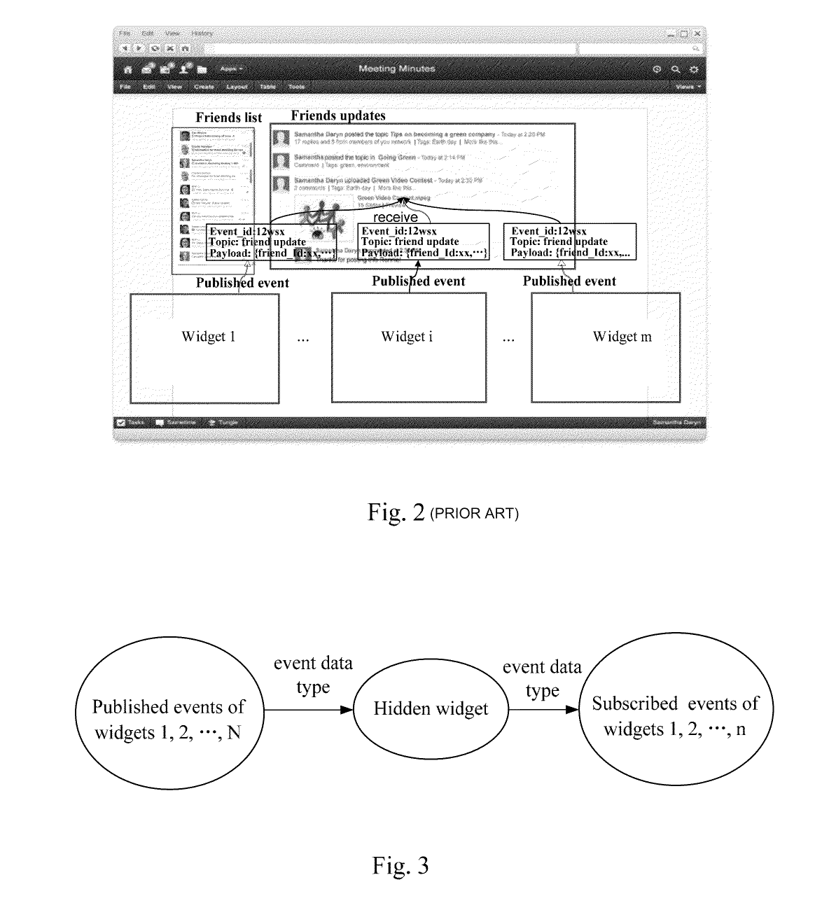

In the following is shown, as an example, part of the definitions of the events published by the main search widget in FIG. 1 in a widget file (since the widget definition file is in compliance with a corresponding specification and template, here only part of the definitions related to the present invention is shown, which is the same in the following examples):

......
<iw:event id=“searchComplete” published=“true”
eventDescName=“desc_searchComplete” />
<iw:eventDescription id=“desc_searchComplete”
payloadType=“searchResult” />
<iw:payloadDef name=“searchResult”>

<iw:payloadDef name=“Date” type=“string”
description=“related date” />
<iw:payloadDef name=“Tag” payloadType=“tagType”
description=“related tag” />
<iw:payloadDef name=“People” payloadType=“peopleType”

description=“related people” />

<iw:payloadDef name=“Country” payloadType=“string”

description=“related country” />

<iw:payloadDef name=“Company” payloadType=“string”

description=“related company” />

<iw:payloadDef name=“Contact” payloadType=“contactType”

description=“result contact” />
</iw:payloadDef>
<iw:payloadDef name=“tagType”>

<iw:payloadDef name=“term” type=“string”
description=“name of the tag” />
<iw:payloadDef name=“frequency” type=“number”

description=“apperance times of the tag” />
......

The parsing process is to, by traversing the definition files of the widgets in the webpage (those skilled in the art know that the related definition files can be obtained through APIs of the widget container), detect whether the value of “published” of an event in the definition files of the widgets is true; and if it is, determine that the event needs to be published.

For example, the event “searchComplete” in the above definition file needs to be published. payloadType=“searchResult” means that the event data type payloadType of the published event is “searchResult”; and <iw:payloadDef name=“searchResult”> and <iw:payloadDef name=“tagType”> represent that the closely followed related event contents are specific definition contents. The specifically published event instance can be represented in json data. A specific example of one published event instance in FIG. 1 is as follows:

......
{

“Date” : “2010, 2009, 2008”,
“Tag” : [ {“term”: “collaboration”, “frequency”: 23} , {“term”: “community”, “frequency”:

19} , {“term”: “ibm”, “frequency”: 15} ],
......

| | |
|---|---|
| “Contacts” | : |

[{″id″:2014,″emailaddress″:″user10@test.com″,″fullname″:″user10@test.com″,″telephon
e″:null,
″mobilephone″:null,″jobtitle″:null,″website″:null,″address″:null},

| | |
|---|---|
| ...... | ] |

}
......

In the following is shown, as an example, the definition of an event subscribing to the event related to tags in the widget file in FIG. 1:

......
<iw:event id=“relatedTags” handled“true” onEvent=“displayTags”
eventDescName=“desc_displayTags” />
<iw:eventDescription id=“desc_displayTags” payloadType=“tagType” />
<iw:payloadDef name=“tagType”>

<iw:payloadDef name=“term” type=“string” description=“name of
the tag” />
<iw:payloadDef name=“frequency” type=“number” condition=“&gt

45”description=“apperance times of the tag” />
</iw:payloadDef>
......

A similar parsing method can be used for subscribed events, and is not repeated here. By parsing the definitions of the published events and subscribed events in the widget definition files in the webpage, the published events and the subscribed events in all the widgets in the webpage can be known.

At step 403, based on the definitions of the published events and the subscribed events, generate a set of published events and a set of subscribed events respectively. Based on the published events and subscribed events known in the previous step, the published events and the subscribed events are formed as a set of published events and a set of subscribed events.

Those skilled in the art know that forming sets is only one implementation, and those skilled in the art can, based on the concept of the present application, contemplate any other suitable forms of data, e.g., the published events and definitions events can also form a list with different identifiers added, and forms such as an array of published events and an array of subscribed events, etc.

At step 405, based on the set of published events and the set of subscribed events, generate a definition file of a hidden widget. At this step, based on the set of published events and the set of subscribed events, and according to the event data types of the subscribed events, match the corresponding published events in the set of published events, and gather the matching events and generate the logic code for republishing the matching events, so that the definition file of the hidden widget is formed.

FIG. 5 shows a preferred embodiment of generating a definition file of a hidden widget. At step 501, traverse the set of published events based on the event data type of at least one subscribed event in the set of subscribed events; at step 503, in response to finding published events matching the event data type in the set of published events, extract corresponding contents of the published events; at step 505, in response to having traversed the set of published events, gather the contents of all the matching published events to form the definition file of the hidden widget. The definitions are in compliance with the related specification of widgets, and the related specification also provides a readymade definition template for the developers; at step 507, generate logic code for republishing the matching published events as part of the definition file of the hidden widget.

The logic code can be JavaScript, and an example of simple main logic code for publishing an event is: this.iContext.iEvents.publishedEvent(“sendData”,dateTime), which represents that an event with the name of sendData, and with the time content of dataTime is published, and the contents of the event instance can be obtained by variable assignment. Those skilled in the art understand that it is common knowledge to automatically generate the logic code for republishing an event based on a related specification of widgets, and in order to save space, it is not repeated here. The following example gives the definition of a republished event in a generated hidden widget definition file:

......
<iw:event id=“republishededEvent” handled=“true”
onEvent=“decomposeEvent”
eventDescName=“desc_decomposeEvent” />
<iw:eventDescription id=“desc_decomposeEvent” />
......
<iw:event id=“ publishededTags” published=“true”
eventDescName=“desc_publishededTags” />
<iw:eventDescription id=“desc_publishededTags”
payloadType=“tagType” />
<iw:payloadDef name=“tagType”>

<iw:payloadDef name=“term” type=“string” description=“name of
the tag” />
<iw:payloadDef name=“frequency” type=“number”

description=“apperance times of the tag” />
</iw:payloadDef>
......

The above first paragraph of definitions presents the subscription code of the hidden widget generated according to the specification, and the second paragraph of definitions is the republished event definition of the event “publishedTags”, and it can be seen that it is (a matching event) extracted from the definitions of the published events of the main search widget.

Another aspect of the present invention provides another preferred embodiment for generating the definition file of the hidden widget. Logic code for processing the set of published event and the set of subscribed events is generated, and the logic code is for: searching in the set of published events based on the event data type of at least one subscribed event in the set of subscribed events; in response to finding published events matching the event data type in the set of published events, extracting corresponding contents of the published events; in response to having traversed the set of published events, gathering the contents of all the matching published events and republishing the matching published events to form the definition file.

The difference between the preferred embodiment mentioned in the directly preceding paragraph and the embodiment shown in FIG. 5 lies in that the logic code generated in this preferred embodiment needs to be responsible for more logic operations, while logic code of the embodiment shown in FIG. 5 only provides the function of republishing the matching events.

Preferably, the set of the published events and the set of subscribed events can be stored in attributes of the definition file of the hidden widget, such that the information of the set of the published events and the set of subscribed events can be directly obtained from the attributes of the hidden widget, thus the event matching processing is convenient.

The present invention also includes loading the hidden widget into the page. The hidden widget is hidden from or transparent to the end user, and it resides in the background processing instances of related published and subscribed events in the webpage (at runtime).

The present invention can be realized by JavaScript (of course, those skilled in the art can realize the present invention based on the present invention by using any other web application development languages), and can be contained in a corresponding widget container.

Web application developers can use the method for the present invention by referencing the related widget container. In this way, the widget is enabled to published all the events it can publish according to the related platform standard specification; and other widgets can also freely subscribe to the published related events based on the related platform standard specification, without needing the programmers to additionally rewrite part of the code of the widget related to the published events and the subscribed events.

If something like iWidget® by IBM® is used as the widget platform, since the platform needs to communicatedly wire widget events through programming or end user wiring, the code for events wiring needs to be rewritten in the HTML document of the webpage, where one rewritten instance is as follows:

The code of event wiring in the original subscribed events is rewritten from:

<span class=“mm_ReceivedEvent”>

<a class=“mm_SourceEvent” href=“#contactMainSearch”
style=“visibility:hidden”>
searchComplete</a>
<span class=“mm_TargetEvent”
style=“visibility:hidden”>relatedTags</span>

</span> ( This segment of code connects the event searchComplete in the
main search widget with the event relatedTags in this widget)

to as follows in the definition file of the hidden widget:

<span class=“mm_ReceivedEvent”>

| <a class=“mm_SourceEvent” href=“#contactMainSearch” | |
|---|---|
| style=“visibility:hidden”> | |
| searchComplete</a> | |
| <span | class=“mm_TargetEvent” |

style=“visibility:hidden”>republishededEvent</span>
</span> (This segment of code connects the event searchComplete in the
main search widget with the event republishedEvent in the hidden widget,
and the republihsedEvent is newly generated)

And the event wiring code in the widget of the subscribed events is rewritten as:

<span class=“mm_ReceivedEvent”>

<a class=“mm_SourceEvent” href=“#hiddenWidget”
style=“visibility:hidden”>
publishededTags</a>
<span class=“mm_TargetEvent”
style=“visibility:hidden”>relatedTags</span>

</span> (This segment of codes connects the event publishedTags in the
hidden widget and the relatedTags of the widget).

The present invention also provides a system 600 for processing published events and subscribed events. System 600 includes: parsing means 601 configured to parse definitions of published events and subscribed events in widget definition files in a webpage; set generating means 603 configured to generate a set of published events and a set of subscribed events based on the definitions of the published events and the subscribed events; and definition file generating means 605 configured to generate a definition file of a hidden widget based on the set of published events and the set of subscribed events.

In addition, the definition file generating means 605 includes: traversing means configured to traverse the set of published events based on event data type of at least one subscribed event in the set of subscribed events; extracting means configured to, in response to finding published events matching the event data type in the set of published events, extract corresponding contents of the published events; gather means configured to, in response to having traversed the set of published events, gather the contents of all the matching published events to form the definition file of the hidden widget; and logic code generating means configured to generate logic code for republishing the matching published events as part of the definition file of the hidden widget.

In addition, system 600 further includes storage means configured to store the set of the published events and the set of the subscribed events into attributes of the hidden widget.

In addition, system 600 further includes loading means configured to load the hidden widget into the page.

In addition, system 600 further includes: rewriting means configured to rewrite the logic code for event wiring in the HTML document of the webpage.

In addition, the definition file generating means 605 includes: logic code generating means configured to generate logic code for processing the set of published events and the set of the subscribed events, the logic codes being for: traversing the set of published events based on the event data type of at least one subscribed event in the set of subscribed events; in response to finding published events matching the event data type in the set of published events, extracting corresponding contents of the published events; in response to having traversed the set of the published events, gathering the contents of all the matching published events and republishing the matching published events to form the definition file of the hidden widget.

FIG. 7 schematically shows a structural block diagram of a computing device which is applicable to implement the embodiments of the present invention. The computer system shown in FIG. 7 includes CPU (central processing unit) 701, RAM (random access memory) 702, ROM (read-only memory) 703, a system bus 704, a hard disc controller 705, a keyboard controller 706, a serial interface controller 707, a parallel interface controller 708, a display controller 709, hard disc 710, keyboard 711, serial peripheral 712, parallel peripheral 713 and display 714. Among these devices, CPU 701, RAM 702, ROM 703, hard disc controller 705, serial interface controller 707, parallel interface controller 707 and display controller 709 are connected with system bus 704. The hard disc 710 is connected with the hard disc controller 705, keyboard 711 is connected with the keyboard controller 706, and the serial peripheral 712 is connected with the parallel interface controller 707, the parallel peripheral 713 is connected with the parallel interface controller 708, and the display 714 is connected with the display controller 709.

The functions of each component in FIG. 7 are well-known in the art, and the structure shown in FIG. 7 is also conventional. Such a structure is applicable not only to personal computers, but also to handheld devices, e.g., Paml PCs, PDAs (personal digital assistant), and mobile phones. In different applications, e.g., when implementing a user terminal containing the client module according to the present invention or a server host computer containing the web application server according to the present application, some components can be added to the structure shown in FIG. 7, or some components in FIG. 7 can be removed.

The entire system shown in FIG. 7 is controlled by computer-readable instructions which are usually stored as software in hard click 710, or stored in EPROM or other non-volatile memories. Software can also be downloaded over the network (not shown in the drawing). Or it can be stored in the hard disc 710, or the software downloaded over the network can be loaded in RAM 702, and executed by CPU 701, so as to accomplish the functions defined by the software.

Although the computer system described in FIG. 7 can support the technical solution provided according to the present invention, the computer system is merely an example of computer systems. Those skilled in the art can understand that many other computer system designs can also realize embodiments of the present invention.

Although the exemplary embodiments of the present invention are described by referring to the accompanying drawings, it should be understood that the present invention is not limited to these specific embodiments, and those of ordinary skill in the art can make various changes to the embodiments without departing from the scope and sprits of the present invention. All these changes and modifications are intended to be included within the scope of the present invention defined in the appended claims.

Moreover, based on the above description, those skilled in the art will appreciate that aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium.

A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM),an erasable programmable read-only memory (EPROM or Flash memory), an optical fiber, a portable compact disc read-only memory (CD-ROM), an optical storage device, a magnetic storage device, or any suitable combination of the foregoing.

In the context of this document, a computer readable storage medium can be any tangible medium that can contain, or store a program for use by or in connection with an instruction execution system, apparatus, or device. A computer readable signal medium can include a propagated data signal with computer readable program code embodied therein, for example, in baseband or as part of a carrier wave. Computer-readable program code can be transmitted using any appropriate medium, including but not limited to wireless, wireline, optical fiber cable, RF, etc.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

In addition, each block of the flowchart illustrations and/or block diagrams of the present invention, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instruction means which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s).

It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Using the method or system of the present invention can save web application developers large amounts of time for amending program code related to subscribed and published events.

What is claimed is:

1. A method for processing published and subscribed events, comprising the steps of:
parsing definitions of published events and subscribed events in widget definition files in a webpage;
generating a set of published events and a set of subscribed events, respectively, based on the definitions of the published events and the subscribed events; and
generating a definition file of a hidden widget based on the set of published events and the set of subscribed events,
wherein at least one step of the method is carried out on a computer device.

2. The method according to claim 1, wherein the generating a definition file step comprises the steps of:
traversing the set of published events based on event data type of at least one subscribed event in the set of subscribed events;
in response to finding published events, in the set of published events, that match the event data type, extracting contents corresponding to the matching published events;
in response to having fully traversed the set of published events, gathering contents of all the matching published events to form the definition file of the hidden widget; and
generating logic code for republishing the matching published events as a part of the definition file of the hidden widget.

3. The method according to claim 1, further comprising the step of:
storing the set of published events and the set of subscribed events into attributes of the hidden widget.

4. The method according to claim 1, further comprising the step of:
loading the hidden widget into the page.

5. The method according to claim 2, further comprising the step of:
rewriting the logic code for event wiring in the HTML document of the webpage.

6. The method according to claim 1, wherein the generating the definition file step comprises the steps of:
generating logic code for processing the set of published events and the set of subscribed events, wherein the logic code is executed on the computer device and causes the computer device to perform the following steps:
traversing the set of published events based on event data type of at least one subscribed event in the set of subscribed events;
in response to finding published events, in the set of published events, that match the event data type, extracting contents corresponding to the matching published events; and
in response to having fully traversed the set of published events, gathering contents of all the matching published events to form the definition file of the hidden widget.

7. A system for processing published and subscribed events, comprising:
at least one computer processor configured to:
parse definitions of published events and subscribed events in widget definition files in a webpage;
generate a set of published events and a set of subscribed events, respectively, based on the definitions of the published events and the subscribed events; and
generate a definition file of a hidden widget based on the set of published events and the set of subscribed events.

8. The system according to claim 7, wherein the at least one processor generates the definition files by being further configured to:
traverse the set of published events based on event data type of at least one subscribed event in the set of subscribed events;
extract, in response to finding published events, in the set of published events, that match the event data type, contents corresponding to the matching published events;
gather, in response to having fully traversed the set of published events, contents of all the matching published events to form the definition file of the hidden widget; and
generate logic code for republishing the matching published events as part of the definition file of the hidden widget.

9. The system according to claim 7, wherein the at least one processor is further configured to:
store the set of published events and the set of subscribed events into attributes of the hidden widget.

10. The system according to claim 7, wherein the at least one processor is further configured to:
load the hidden widget into the page.

11. The system according to claim 8, wherein the at least one processor is further configured to:
rewrite the logic code for event wiring in the HTML document of the webpage.

12. The system according to claim 7, wherein the at least one processor generates the definition files by being further configured to:
generate logic code for processing the set of published events and the set of subscribed events, wherein the logic code further configures the at least one processor to:
traverse the set of published events based on event data type of at least one subscribed event in the set of subscribed events;
extract contents that correspond to published events matching the event data type, in response to finding the published events, in the set of published events, that match the event data type; and
gather contents of all the matching published events to form the definition file of the hidden widget, in response to having fully traversed the set of published events.

13. A non-transitory article of manufacture tangibly embodying computer readable instructions, which when implemented, cause a computer to carry out the steps for processing published and subscribed events, the method comprising the steps of:
parsing definitions of published events and subscribed events in widget definition files in a webpage;
generating a set of published events and a set of subscribed events, respectively, based on the definitions of the published events and the subscribed events; and
generating a definition file of a hidden widget based on the set of published events and the set of subscribed events,
wherein at least one step of the method is carried out on a computer device.

14. The article of manufacture according to claim 13, wherein the method further comprises the steps of:
traversing the set of published events based on event data type of at least one subscribed event in the set of subscribed events;
in response to finding published events, in the set of published events, that match the event data type, extracting contents corresponding to the matching published events;
in response to having fully traversed the set of published events, gathering contents of all the matching published events to form the definition file of the hidden widget; and
generating logic code for republishing the matching published events as a part of the definition file of the hidden widget.

15. The article of manufacture according to claim 13, wherein the method further comprises the step of:
storing the set of published events and the set of subscribed events into attributes of the hidden widget.

16. The article of manufacture according to claim 13, wherein the method further comprises the step of:
loading the hidden widget into the page.

17. The article of manufacture according to claim 14, wherein the method further comprises the step of:
rewriting the logic code for event wiring in the HTML document of the webpage.

18. The article of manufacture according to claim 13, wherein the method further comprises the steps of:
generating logic code for processing the set of published events and the set of subscribed events, wherein the logic code is executed on the computer device and causes the computer device to perform the following steps:
traversing the set of published events based on event data type of at least one subscribed event in the set of subscribed events;
in response to finding published events, in the set of published events, that match the event data type, extracting contents corresponding to the matching published events; and
in response to having fully traversed the set of published events, gathering contents of all the matching published events to form the definition file of the hidden widget
